(19) United States
(12) Patent Application Publication
(10) Pub. No.: US 2015/0260624 A1
(43) Pub. Date: Sep. 17, 2015

(54) SNAP GRIP INDENTER MOUNT USED ON A HARDNESS TESTER

(71) Applicant: ILLINOIS TOOL WORKS INC., Glenview, IL (US)

(72) Inventors: Stephen M. McMahon, Quincy, MA (US); Michael D.R. Dakin, Chicago, IL (US); Nicholas M. Blanchard, Merrimack, NH (US); Christopher E. Kade, N. Attleboro, MA (US); James B. Smallwood, Milton, MA (US)

(21) Appl. No.: 14/441,181

(22) PCT Filed: Nov. 8, 2013
(86) PCT No.: PCT/US13/69306

§ 371 Date: May 7, 2015

Related U.S. Application Data
(60) Provisional application No. 61/733,548, filed on Dec. 5, 2012.

(51) Int. Cl. G01N 3/42

(52) U.S. Cl. CPC G01N 3/42

(57) ABSTRACT

The present disclosure relates to a snap grip indenter mount, used on a hardness tester, particularly a microhardness tester, or similar apparatus. The snap grip indenter mount includes three major components—an indenter ball adapter, an upper housing assembly (or snap-grip male element) and a lower housing assembly (or snap-grip female element). The indenter ball adapter forms a ball-and-socket arrangement with the lower housing assembly. The lower housing assembly includes various set screws for fixing the orientation and symmetry of the indenter ball adapter with the lower housing assembly.

This application claims priority under 35 U.S.C. 119(e) of U.S. provisional patent application Ser. No. 61/733,548, filed on Dec. 5, 2012, the disclosure of which is hereby incorporated by reference in its entirety.

### BACKGROUND OF THE DISCLOSURE

1. Field of the Disclosure

The present disclosure relates to a snap grip indenter mount, used on a hardness tester, particularly a microhardness tester, or similar apparatus.

2. Description of the Prior Art

Hardness, a material's resistance to permanent deformation, is generally measured on either a Brinell, a Rockwell or a Microhardness testing machine. In a microhardness test, a four-sided pyramidal diamond indenter is pressed into the sample's surface with a controlled force. The indenter is removed and the lengths of the diagonals of the indentation left in the surface of the sample are measured using a microscope. The hardness is calculated (usually by the software) using the test force and the area of indentation.

A microhardness tester can be fitted with at least two indenter types, including a Vickers indenter and Knoop indenter. A Vickers indenter is a symmetrical four-sided pyramid; it makes a square-shaped indent. Both diagonals are measured to calculate the hardness. A Knoop indenter is highly asymmetrical in that it makes an elongated (7:1) rhomboidal indent. Only the long diagonal is measured and used for the hardness calculation.

Microhardness testers are generally equipped with multiple indenters and multiple microscope objectives all mounted on a multi-position rotatable turret. To run tests, the turret rotates to position the indenter above the test sample, the indent is made and the turret rotates to an objective position so the user (and the software) can view and measure the indent.

To make symmetrical indents on a test sample, the diamond indenter must contact the surface with a precise angular orientation. That is, the indenter axis and the surface of the test sample must be mutually perpendicular in both axes within 3 arc-minutes. Two adjustable horizontal axes are required because such a tight angular tolerance is not achievable with fixed parts, even with the most precise machining.

A third indent orientation—rotation of the indent about the viewing axis must also be controlled. Opposite indent corners need to be oriented left-to-right and front-to-back within a half degree or so. This rotational alignment is needed mostly because users typically expect the indents to be visually aligned with the primary axes—a crooked indent is a sign of poor machine quality. In addition, because indent length is measured automatically by two pairs of software filars (one pair is exactly vertical and one pair is exactly horizontal), many users would assume that an indent with a visually perceptible angle would be inaccurately measured by the software filars—even though an indent with a very apparent 2.5 degree angle would be measured accurately, typically within 0.1 percent, by the filars.

To achieve “indent symmetry”, Wilson Tukon 2100 and Tukon 2500 testers use an arrangement of thin shims (0.001″ & 0.003″ thick sheet metal washers) to adjust the angle of the X-Y stage. Two Knoop indents (one horizontal and one vertical) are made with the unshimmed tester, indent asymmetry is measured and the measurements are used to calculate the thicknesses of the shims needed to correct the asymmetry. The X-Y stage is removed from the tester, the shims are placed around the four screws that clamp the X-Y stage to the loadframe and the X-Y stage is refitted to the machine. Finally, two more Knoop indents are made to verify the results of shimming

The TU2500 does not have a fine rotation adjustment of the indent orientation. The user must manually rotate the indenter with a one millimeter tommy-bar temporarily placed through the transverse hole in the indenter.

Various companies manufacture devices which adjust their indenter symmetry, probably through an adjustment mechanism of some sort. Similarly, a four axis (two translations and two rotations) alignment device exists for adjusting the alignment of tensile test specimens. It is manufactured by the Interlaken Company, see U.S. Pat. No. 5,377,549, issued on Jan. 3, 1995.

In commonly-owned U.S. Pat. No. 7,004,017, issued Feb. 28, 2006, a canted-coil spring serves to center the indenter and draw its shoulder into firm compressive contact with the end face of the coupling.

Additionally, commonly-owned PCT/US2012/053750 entitled, “Apparatus for Microscopic Detection of Hardness”, filed on Sep. 5, 2012, while well-suited for its intended purposes, does not include a snap grip feature.

Generally, the prior art “shimming-at-the-stage” symmetry adjustment method is acceptable (i.e., the indent can be made symmetric) but the method is time consuming and requires temporary removal of the X-Y stage so the shims can be installed. The heavy weight of the stage and its proximity to the microscope objectives and indenters makes stage removal and installation a risky task—there is a big risk of jerking the heavy X-Y stage up and into the microscope and loadcell components as the thread that holds the stage down suddenly releases.

Another disadvantage of shimming-at-the-stage is that because the sample surface is tipped by shimming, the focus plane of the microscope changes and some part of the view will lose focus.

A further deficiency of the prior art method is that the “before-shimming indent” cannot be found for comparison against the “after-shimming indent” because the stage is removed from the machine and replaced (not in exactly the same position) after shimming.

Vickers and Knoop indenters are machined with such accuracy that an indenter can usually be removed from the machine mount and replaced with another indenter and indent symmetry will be retained. However, indent rotational orientation will always be lost when changing an indenter. This is a big problem because indent rotational orientation is a tedious, hit-or-miss task with the prior art method where the operator will usually overshoot or undershoot the position with each rotational adjustment of the indenter with the not-so-controllable tommy-bar rotational adjustment. The adjustment of indent rotational orientation is frequently thought to be the single most difficult thing to do on the TU2500 machine.

### OBJECTS AND SUMMARY OF THE DISCLOSURE

It is therefore an object of the present disclosure to provide for simplified adjustment of the indenter in hardness tester or similar materials testing apparatus.

This and other objects are attained by providing a ball joint that is set-screw-adjusted. Because symmetry adjustment is done at the indenter, the stage stays in place during adjustment and the focus plane is unaffected by the adjustments. The center of the ball joint is at the tip of the diamond indenter, so the indenter tip does not translate as the angle is adjusted. This means the adjusted indent can be placed adjacent to the “before-shimming indent” for visual verification of the adjusting action.

The combination of the snap grip coupling and the two-pin rotational orientation mechanism allow a user to change out an indenter/lower housing assembly without needing to redo any alignment adjustment. The user can remove a Knoop indenter and install a Vickers indenter and continue testing without interruption.

This disclosure addresses the ease of adjusting the indent orientation by using two opposing set screws to make the adjustment—fine adjustment of the set screws is easy and tightening both screws offers a secure locked position. This disclosure also provides a way to snap the lower housing assembly into a repeatable position every time it is installed—there is typically no need to adjust symmetry or indent orientation.

### BRIEF DESCRIPTION OF THE DRAWINGS

Further objects and advantages of the disclosure will become apparent from the following description and from the accompanying drawings, wherein:

FIG. 1 is a perspective, partially exploded, view of the embodiment of the indenter mount of the present disclosure.

FIG. 2 is a perspective exploded view of the embodiment of the indenter mount of the present disclosure.

FIG. 3A is a top plan view, partially in phantom, of the female component or upper housing assembly of the indenter mount of the embodiment of the present disclosure.

FIG. 3B is a cross-sectional view along plane 3B-3B of FIG. 3A.

FIG. 3C is a top perspective view, partially in phantom, of the female component or upper housing assembly of the indenter mount of the embodiment of the present disclosure.

FIG. 3D is a bottom perspective view, partially in phantom, of the female component or upper housing assembly of the indenter mount of the embodiment of the present disclosure.

FIG. 3E is a side plan view of the female component or upper housing assembly of the indenter mount of the embodiment of the present disclosure.

FIG. 3F is an area in detail from FIG. 3B.

FIG. 3G is a top plan view, partially in phantom, of the female component or upper housing assembly of the indenter mount of the embodiment of the present disclosure.

FIG. 3H is a bottom plan view, partially in phantom, of the female component or upper housing assembly of the indenter mount of the embodiment of the present disclosure.

FIG. 4A is a top plan view of the male component or lower housing assembly of the indenter mount of the embodiment of the present disclosure.

FIG. 4B is a cross-sectional view along section 4B-4B of FIG. 4A.

FIG. 4C is an area in detail from FIG. 4B.

FIG. 4D is a side plan view of the male component or lower housing assembly of the indenter mount of the embodiment of the present disclosure.

FIG. 4E is a bottom plan view of the male component or lower housing assembly of the indenter mount of the embodiment of the present disclosure.

FIG. 4F is a top perspective view of the male component or lower housing assembly of the indenter mount of the embodiment of the present disclosure.

FIG. 4G is a bottom perspective view, partially in phantom, of the male component or lower housing assembly of the indenter mount of the embodiment of the present disclosure.

FIG. 5A is a bottom plan view of the indenter ball adapter of the indenter mount of an embodiment of the present disclosure.

FIG. 5B is a side plan view of the indenter ball adapter of the indenter mount of an embodiment of the present disclosure.

FIG. 5C is a bottom perspective view of the indenter ball adapter of the indenter mount of an embodiment of the present disclosure.

FIG. 5D is a top perspective view of the indenter ball adapter of the indenter mount of an embodiment of the present disclosure.

FIG. 5E is a cross-sectional view along plane 5E-5E of FIG. 5B.

FIG. 6A, 6B, 6C and 6D are schematics of various possible orientations of the indents formed by the indenter.

FIGS. 7A, 7B and 7C illustrate further orientations of the indents formed by the indenter.

### DETAILED DESCRIPTION OF THE PREFERRED EMBODIMENTS

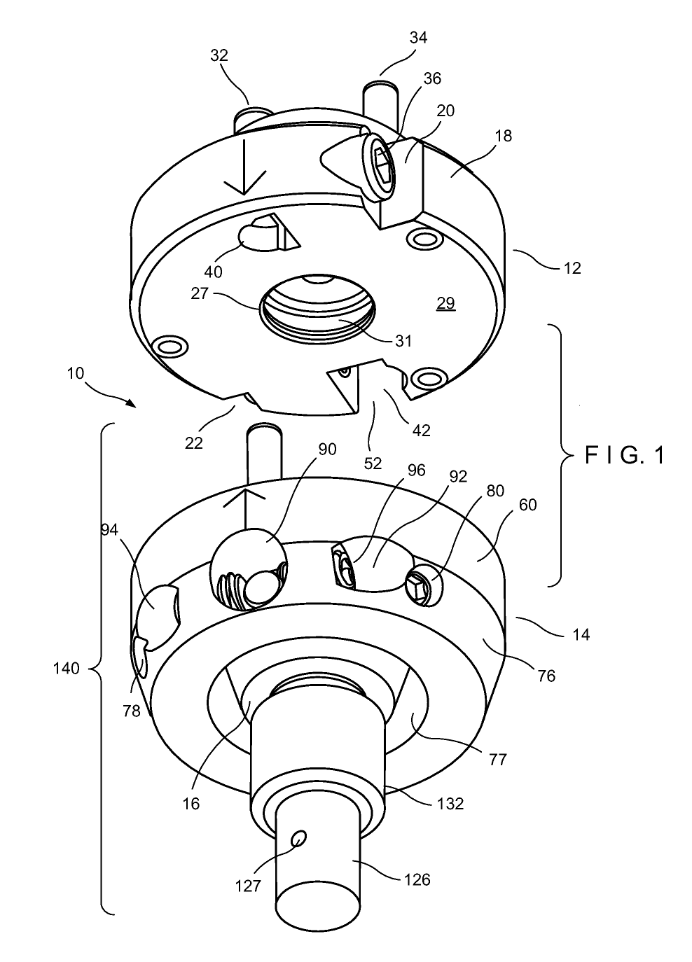

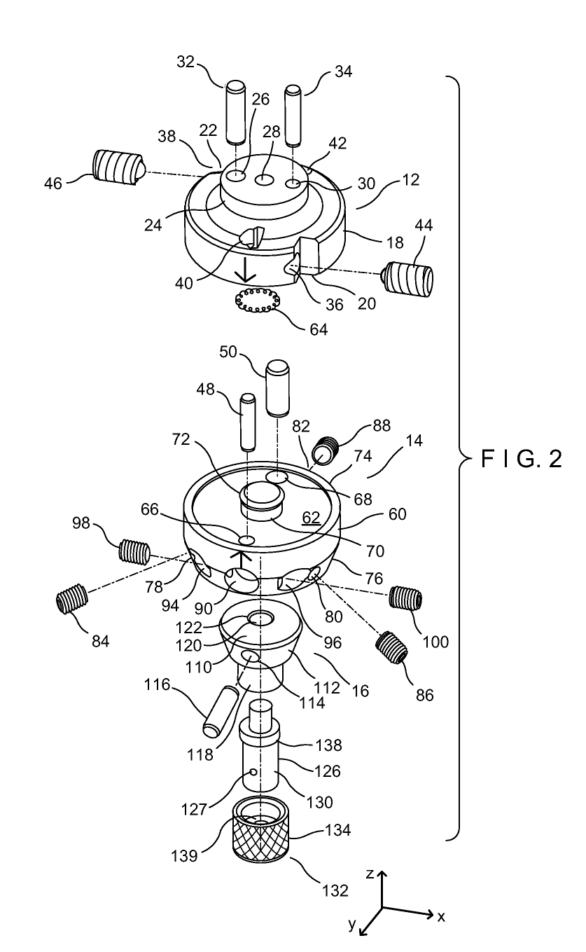

Referring now to the drawings in detail wherein like numerals refer to like elements throughout the several views, one sees that FIGS. 1 and 2 are exploded views of the snap grip indenter mount 10 of the present disclosure. The snap grip indenter mount 10 is made from high grade metal as appropriate for the forces which are expected to be encountered. This high grade metal may be, but is not limited to, stainless steel. The snap grip indenter mount 10 includes three major components—the upper housing assembly (or snap grip female element) 12, the lower housing assembly (or the snap grip male element) 14 and the indenter ball adapter 16.

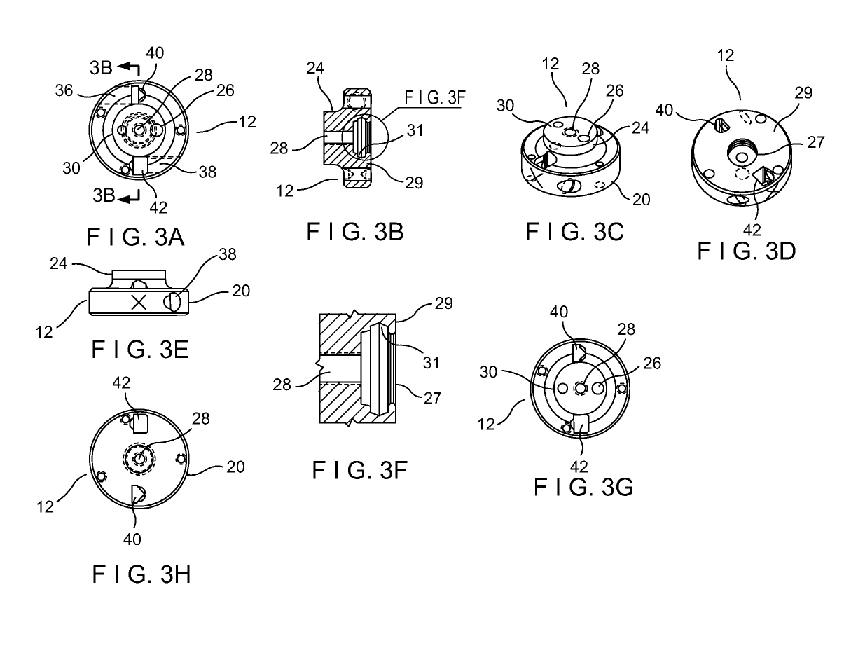

The upper housing assembly 12 is shown in further detail in FIGS. 3A-H. The upper housing assembly 12 includes a generally cylindrical lower base 18 with first and second V-shaped notches 20, 22. Cylindrical upper base 24 extends from cylindrical lower base 18 and includes first, second and third longitudinal apertures 26, 28, 30. First and third longitudinal apertures 26, 30 are blind apertures which receive respective first and second loadcell pins 32, 34 to a loadcell (not shown) while second longitudinal aperture 28 is threaded to receive a securing screw from the loadcell and passes through the upper female housing assembly 12 and is centered on the rotational axis of the snap grip indenter mount 10 and includes an expanded cylindrical female mounting opening 27 in the lower planar floor 29 (see FIG. 1). As shown in FIGS. 3B and 3F, expanded cylindrical mount opening 27 further includes an interior annular groove 31 that receives canted coil spring 64. First and second transverse passageways 36, 38 are formed in respective first and second V-shaped notches 20, 22 and lead to respective first and second longitudinally-oriented peripheral passageways 40, 42. First and second transverse passageways 36, 38 receive respective first and second spring-loaded ball plungers 44, 46 which nest or bear upon the first and second inter-assembly pins 48, 50 extending from lower housing assembly 14 whereby the first and second spring-loaded ball plungers 44, 46 provide a rotational nesting force. As can be seen from FIGS. 1 and 2, second inter-assembly pin 50 has a greater diameter than first inter-assembly pin 48, thereby requiring that second longitudinal peripheral passageway 42 have a greater diameter, giving the pays a “keyed” one-way-only assembly. Further, as can be seen in FIG. 1, second longitudinal peripheral passageway 42 includes an open lateral portion 52.

As shown in FIGS. 1, 2 and 4A-G, the lower housing assembly 14 includes a generally cylindrical body 60 with an upper generally planar surface 62. A canted coil spring 64 (see FIG. 2) serves to draw together the lower planar floor 29 of the upper housing assembly 12 and the upper planar surface 62 of the lower housing assembly 14. The upper planar surface 62 includes first and second lower blind apertures 66, 68, appropriately sized for receiving respective first and second inter-assembly pins 48, 50. Male mounting element 70 extends from the center of upper planar surface 62 and further includes a distal circumferential lip 72. Male mounting element 70, including circumferential lip 72, is configured to snap detent engage the canted coil spring 64. The upper planar surface 62 is further bounded by a lip 74 about its periphery.

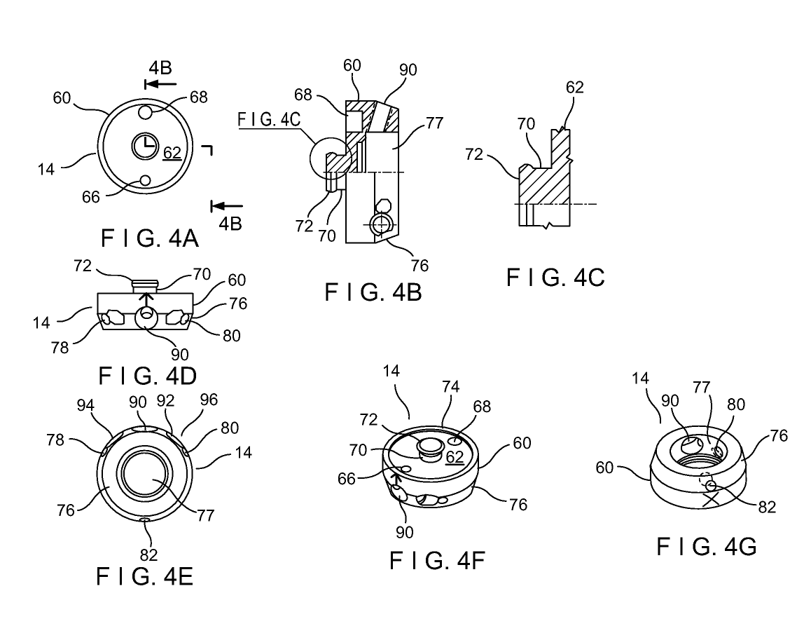

As seen in FIGS. 1 and 4A-G, the lower housing assembly 14 further includes lower circumferential wall 76 defining lower concave cavity 77 for receiving the indenter ball adapter 16. The lower circumferential wall 76 includes first, second and third radially oriented threaded apertures 78, 80, 82 for receiving respective first, second and third symmetry adjusting screws 84, 86, 88 which impinge against the indenter ball adapter 16 and are used to adjust and subsequently lock the two rotational horizontal axes. In other words, the first, second and third symmetry adjusting screws 84, 86, 88 are used to adjust the two angles of the indent ball adapter 16 thereby affecting the symmetry of the indent. In the illustrated embodiment of FIG. 2, the third radially oriented aperture 88 is oriented toward the second lower blind aperture 68 while the first and second radially oriented apertures 84, 86 are oriented 120 degrees on either side of third radially oriented aperture 88.

Additionally, lower circumferential wall 76 includes a fourth radially oriented aperture 90, typically unthreaded and, as shown in FIG. 4B, somewhat downwardly inclined, through which the indenter ball orientation adjustment pin 116 (described below) of indenter ball adapter 16 extends. The fourth radially oriented aperture 90 is typically oriented 180 degrees from the third radially oriented aperture 82 and rotationally equidistant between the first and second radially oriented apertures 78, 80. Lower transverse threaded passageway 92 intersects fourth radially oriented aperture 90 and includes first and second openings 94, 96 which receive respective first and second orientation adjusting screws 98, 100. The third rotational axis (the vertical Z axis—the indent orientation axis) is adjusted and locked by first and second orientation adjusting screws 98, 100 which are threaded into the lower transverse threaded passageway 92 and have their flat ends bearing the indenter ball orientation adjustment pin 116 which protrudes from fourth radially oriented aperture 90.

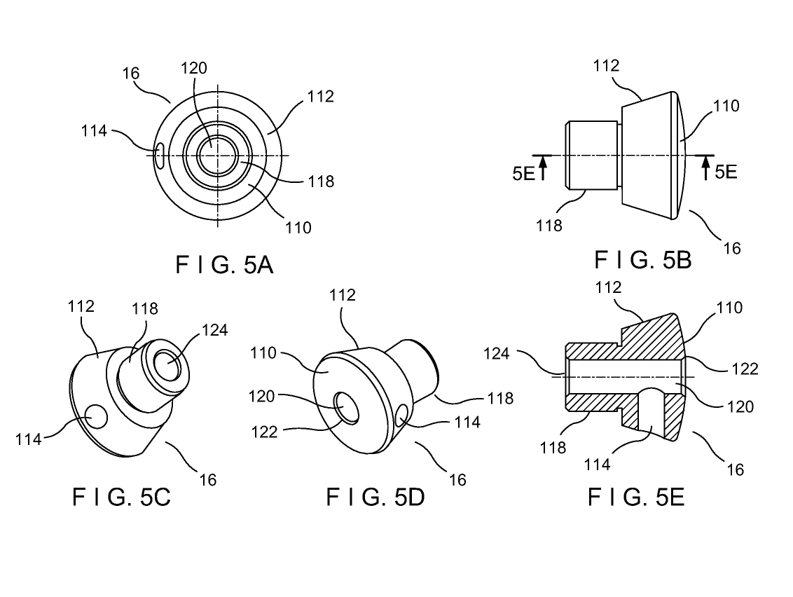

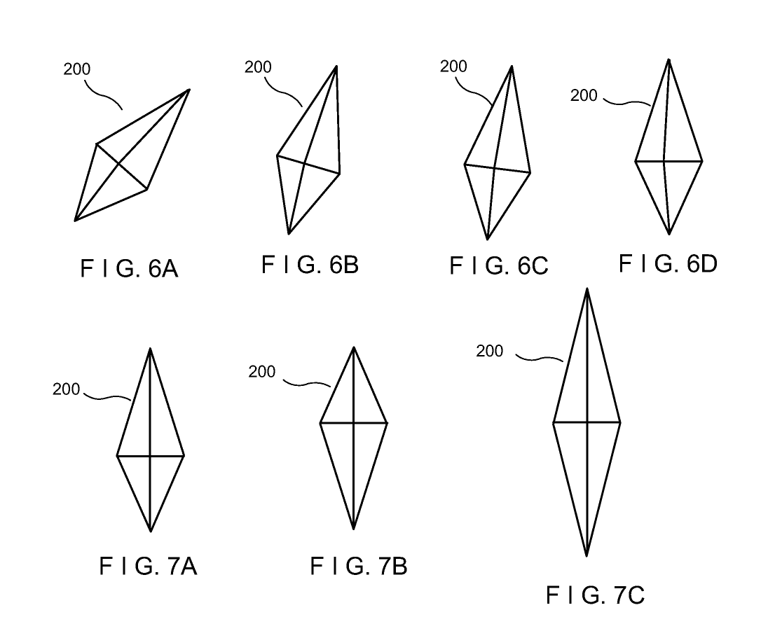

The indenter ball assembly 16, illustrated in FIGS. 1, 2 and 5A-E, includes a partially spherical ball-type convex surface 110 for engaging the interior of lower concave cavity 77 of lower housing assembly 14 thereby forming a ball joint or ball and socket arrangement to allow three rotational degrees-of-freedom. The indenter ball assembly 16 further includes frustoconical wall 112 extending downwardly from partially spherical ball-type surface 110. Frustoconical wall 112 includes radially oriented pin receiving aperture 114 for receiving and engaging the indenter ball orientation adjustment pin 116. Typically, in assembling the snap grip indenter mount 10, the indenter ball orientation adjustment pin 116 is not inserted into the radially oriented pin receiving aperture 114 until after the indenter ball assembly 16 is engaged within the interior of lower concave cavity 77 of lower housing assembly 14. As shown in FIGS. 5A-E, a cylindrical stem 118 is formed below the frustoconical wall 112. Further, central indenter mount passageway 120 extends through the entire longitudinal axis of indenter ball assembly 16 forming a first opening 122 in partially spherical ball-type surface 110 and a second opening 124 at the end of cylindrical stem 118. As shown in FIG. 2, the second opening 124 is used to receive upper cylindrical mounting boss 128 of cylindrical indenter 126. As shown in FIG. 2, cylindrical indenter 126 includes cylindrical wall 130 further includes a rim 138 for being face-to-face engaged by the lower lip 139 formed on cylindrical wall 134 of the indenter retainer 132. The cylindrical indenter 126, which may be separately provided, further includes the diamond-shaped protrusions (not shown) to make indents 200 in the sample which is being hardness tested as illustrated in FIGS. 6A-D and 7A-C. Transverse aperture 127 is formed in indenter 126 to indicate the orientation of the protrusion which forms indents 200.

The upper and lower housing assemblies 12, 14 can be separated and reconnected with the snap action given by the canted coil spring 64 as it engages circumferential lip 72. The symmetry and orientation of the snap grip indenter mount 10 will typically always be the same. With this configuration, the user can have multiple indenter/lower housing assemblies 140 that have each been adjusted to the one upper housing assembly 12 so the user can at any time remove a lower housing assembly 14, typically simply by pulling it down, and replace it with another lower housing assembly 14, and not have to make any symmetry or orientation adjustments. Typically, this embodiment of the disclosure is used in compression only.

The typical operation of the embodiment of the disclosure is as follows (assuming the starting point of an assembled lubricated indenter mount assembly 10, which has yet to be adjusted).

### Part 1: Vertical Coarse Rotational Adjustment

1. The user checks that a Knoop Indenter, or similar, is installed as element 126 or an extension thereof. If not, the user:
a. Typically unscrews the indenter retainer 132 in a counter clockwise direction (when the indenter 126 is pointing towards the user) or some similar operation.
b. The previously installed indenter should drop out. The user replaces with Knoop indenter as indenter 126 and lines the transverse aperture 127 in the indenter 126 up with the front facing pin using a small drill blank or paper clip.
c. The user screws back on the indenter retainer 132.

2. The user inserts the lower housing assembly 14 and makes a single indent 200 in the sample.

3. The user checks that the resulting indent 200 on the sample is vertical (within a few degrees). If not, the user unscrews the indenter retainer 132 and moves the indenter 126 and then tightens again, makes an indent 200 in the sample and repeats until the indent 200 is vertical within 5 degrees (see, for example, FIG. 6D as compared to FIGS. 6A-C).

4. Once the indent 200 is within 5 degrees of being vertical, the user uses the first and second orientation adjusting screws 98, 100 in the lower housing assembly 14 to adjust the vertical alignment of the indents.

5. Once the indents are vertically aligned, the symmetry is adjusted.

### Part 2: Vertical (Front-to-Rear) Symmetry.

Once the indents are vertically aligned, the symmetry is adjusted as described below
1. If the indent 200 looks like FIG. 7A (the rear portion longer than the front portion), then the user should equally loosen the two front symmetry adjusting screws 84, 86 (see FIG. 2) and then tighten the rear symmetry adjusting screw 88.
2. If the indent 200 looks like FIG. 7B (the rear portion is shorter than the front portion), then the user should loosen the rear symmetry adjusting screw 88 (see FIG. 2) and then equally tighten the two front symmetry adjusting screws 84, 86.
3. If the indent 200 looks like FIG. 7C (front and rear portions equal), then the vertical symmetry has been adjusted.

### Part 3: Horizontal (Left-to-Right) Alignment and Symmetry

1. The user typically unscrews the indenter retainer cap 132 and rotates the indenter 126 by 90 degrees to obtain a left-to-right indent. The user typically does not adjust the first and second rotational adjusting screws 98, 100.

2. The user typically adjusts the two front symmetry adjusting screws 84, 86. The user typically does not adjust the two front symmetry adjusting screws 98, 100 or the rear symmetry adjusting screw 88. The user adjusts screws 84, 86 until the indent 200 is symmetric about the y-axis.

### Part 4: Vertical Fine Rotational Adjustment

The user rotates the indenter 126 again to give a front-to-back axis orientation and makes an indent 200 on the sample to check that the indent 200 has remained symmetric about the x-axis. The user make adjustments to screws 98, 100 to adjust the rotational orientation of the indent within 0.5 degrees.

The user is then ready to perform microhardness or similar testing.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. An apparatus for connecting a loadcell to an indenter for materials testing, including; a
first assembly component including a first engagement element and a load receiving element;
a second assembly component including a second engagement element and a first swivel component; and
an adapter component including a second swivel component and an indenter engaging element.

2. The apparatus of claim 1 wherein the first swivel component is a first element of a ball and socket arrangement.

3. The apparatus of claim 2 wherein the second swivel component is a second element of a ball and socket arrangement.

4. The apparatus of claim 3 wherein the first swivel component is a cavity formed on a bottom of the second assembly component.

5. The apparatus of claim 4 wherein the second swivel component is a convex surface which engages the cavity thereby forming the ball and socket arrangement.

6. The apparatus of claim 5 wherein the ball and socket arrangement provides three rotational degrees of freedom between the second assembly component and the adapter component.

7. The apparatus of claim 6 wherein the first engagement element engages the second engagement element.

8. The apparatus of claim 7 wherein engagement between the first engagement element and the second engagement element is a snap engagement.

9. The apparatus of claim 8 wherein the first engagement element is a female element.

10. The apparatus of claim 9 wherein the second engagement element is a male element for engaging the female element.

11. The apparatus of claim 10 wherein the female element includes an internal annular groove to receive a spring element.

12. The apparatus of claim 11 wherein the male element includes a circumferential lip for snap engaging the spring element.

13. The apparatus of claim 12 wherein the cavity is surrounded by a generally cylindrical wall.

14. The apparatus of claim 13 wherein the generally cylindrical wall includes at least three radially oriented apertures which are at least partially threaded for receiving set screws for bearing against the adapter component and for adjusting symmetry of the second assembly component with respect to the adapter component.

15. The apparatus of claim 14 wherein the generally cylindrical wall includes an adapter pin aperture which is radially oriented, and wherein the adapter element includes a radially oriented pin which extends through the adapter pin aperture.

16. The apparatus of claim 15 wherein the adapter element includes frustoconical walls extending from the convex surface, and wherein the radially oriented pin extends from said frustoconical surface.

17. The apparatus of claim 16 wherein the generally cylindrical wall includes a transverse passageway with a first opening and a second opening on a surface of the generally cylindrical wall, wherein the transverse passageway intersects with the adapter pin aperture.

18. The apparatus of claim 17 wherein the first and second openings receive respective first and second orientation adjusting set screws which bear against the radially oriented pin for adjusting orientation of the second assembly component with respect to the adapter component.

19. The apparatus of claim 18 wherein the adapter component includes a longitudinal passageway for receiving an indenter.

20. The apparatus of claim 19 wherein first and second inter-assembly engagement pins extend from the second assembly component and through respective first and second longitudinally-oriented peripheral passageways.
